(19) United States
(12) Patent Application Publication
(10) Pub. No.: US 2008/0222912 A1
(43) Pub. Date: Sep. 18, 2008

(54) DEVICE AND METHOD FOR DRYING CONTAINERS

(75) Inventor: Wolfgang Hahn, Donaustauf (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KRONES AG, Neutraubling (DE)

(21) Appl. No.: 12/049,085

(22) Filed: Mar. 14, 2008

(30) Foreign Application Priority Data
Mar. 17, 2007 (DE) 10 2007 012 873.3

(51) Int. Cl. F26B 15/00

(52) U.S. Cl. 34/437; 34/105; 34/89; 34/524

(57) ABSTRACT

A device and method for drying containers, in particular bottles, having a drying unit for removing water on the container surface. The drying process saves energy and is adapted to ambient conditions, so that labels, for example, can be applied reliably in a downstream labeling machine. The device includes at least one measuring unit for measuring ambient parameters. In addition, a control unit designed so that the drying performance of the drying unit can be regulated as a function of at least one measured ambient parameter is provided. The device and method makes it possible to prevent the condensation of water on the container surface or to keep it below a certain minimum.

The present application claims the benefit of priority of which application claims priority of German Patent Application No. 10 2007 012 837.3, filed Mar. 17, 2007. The entire text of the priority application is incorporated herein by reference in its entirety.

### FIELD OF THE INVENTION

The disclosure relates to a device and a method for drying containers, such as for bottles in the beverage bottling industry.

### BACKGROUND

In bottling installations in the beverage industry, containers (primary packagings), in particular bottles, are furnished with finishing items such as labels. This is done in a continuous process. Adhesion of the label is accomplished with glue/adhesive directly on the container. However, this type of bonding is problematical, in particular with hot glue and self-stick labels. For a good quality of the bonding/finishing item, the container must have only limited moisture. The acceptable amount of water on the containers, e.g., made of glass or PET, is less than approx. 0.5 g/container, depending on the container size, the container shape and the type of machine with which the label is applied, for example.

To reduce the amount of water on the containers, drying units are generally used. With such equipment, e.g., by means of fans, air is blown onto the containers at a high speed through so called air nozzles and/or air knives. The water is thereby mostly removed mechanically. Such drying units are described in EP 1028300 A1 and U.S. Pat. No. 2,501,367, for example.

The causes of water on containers include, for example:
the filling system (rinsing, spraying off the threads),
aftertreatment (spray) of the filled container (e.g., because of the product foaming over),
pasteurization (e.g., tunnel pasteur) and
condensation, etc.

Condensation is a special problem because it occurs only seasonally depending on the climate and the production temperature and then only on a few days per year.

### SUMMARY OF THE DISCLOSURE

Against this background, the object of the present disclosure is to make available a device and/or a method for drying containers that will allow energy-saving drying adapted to environmental conditions so that labels can be applied reliably in a downstream labeling machine.

According to the present disclosure, the drying power is regulated as a function of the measured ambient parameters, so this guarantees that the drying process can always be adapted to the ambient parameters that are relevant for condensation. It is thus possible to ensure that the amount of condensed water on the container is in the range of less than approx. 0.5 g per container. Adapting the drying to the ambient conditions also permits not insignificant energy savings because the lowest possible heating output may be used, making it possible to prevent condensation on a container surface or to keep it below a certain limit. According to the present disclosure, the drying power is regulated so that there is practically no interfering condensation on the container surface. The containers may thus be reliably provided with finishing items, in particular labels. The term “regulating the drying performance” is to be understood as referring to the manual adjustment as well as automatic regulating or controlling of drying.

The at least one measuring unit may supply the measured values directly to the control unit. However, an input device may also be provided for entering measured ambient parameters or known values such as the type of container or process-specific data. Thus, for example, certain parameters such as the bottle temperature may also be measured at another location and then entered for the purpose of regulating the drying performance.

The device advantageously comprises a measuring unit for the air temperature and a measuring unit for the atmospheric humidity.

The device may also comprise a measuring unit for measuring the humidity on the container surface. For example, the amount of condensate per container or the relative humidity in percent may be determined.

The control unit advantageously determines the dew point at which condensation of water occurs on the container surface from the measured ambient parameters, such as the air temperature and the atmospheric humidity. The dew point is then used as the basis for regulating the drying performance. In particular by comparing the container temperature, especially the surface temperature, with the dew point thus ascertained, the drying performance can be regulated.

It is advantageous if the control unit is connected to a display which displays a signal as a function of the measured parameters, said signal indicating whether the heating output should be increased or decreased to prevent condensation or save energy. If the device has such a display, the performance of the drying unit can then be regulated manually. However an acoustic warning signal may also be delivered.

However, the performance of the drying unit can also be regulated automatically via the control unit.

The performance of the drying unit can be increased for example by increasing the energy input for individual parts, e.g., to increase the fan power and/or the amount of thermal energy supplied. However it is also possible to automatically or manually activate or deactivate parts of the drying unit to regulate the drying performance as a function of the measured ambient parameters and/or to activate or deactivate the complete drying installation.

According to another embodiment of the present disclosure, the drying unit may additionally comprise a device for reducing condensation by reducing atmospheric humidity and/or lowering the air temperature. Such a device may be activated as needed to prevent condensation.

### BRIEF DESCRIPTION OF THE DRAWINGS

The present disclosure is described below on the basis of the drawings.

FIG. 1 shows an embodiment of the disclosure in a schematic diagram.

FIG. 2 shows schematically a part of another embodiment according to the disclosure.

FIG. 3 shows a flowchart illustrating several sequence possibilities for the disclosed method.

FIG. 4 shows a preferred exemplary embodiment of the disclosed method.

### DETAILED DESCRIPTION OF THE PREFERRED EMBODIMENT

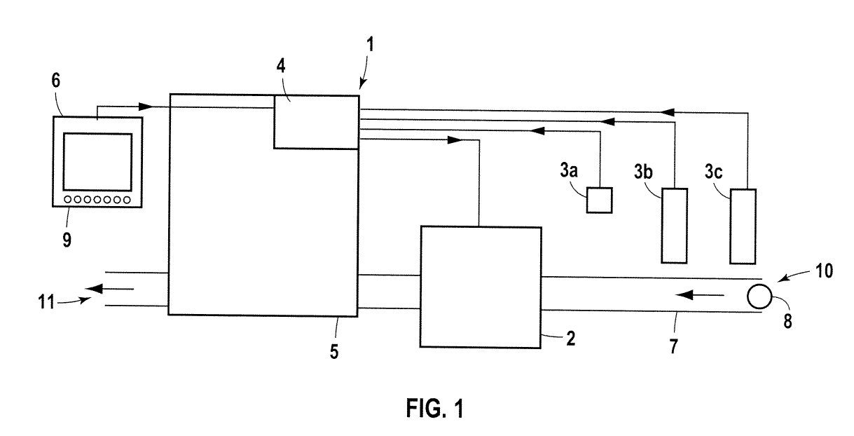

FIG. 1 shows the disclosed device 1 for drying, having a drying unit 2, which is situated in front of a labeling machine 5. Containers, namely bottles 8 here, are conveyed through the drying unit 2 and the labeling machine 5 to the outlet 11 by a conveyer device 7. The drying unit 2 reduces the amount of water on the containers so that the labeling machine 5 can apply a label to the container in such a manner that it will adhere well. The drying unit 2 may have air nozzles (not shown here), for example, which blow moisture away from the container surface. For drying, the containers may additionally be rotated about their longitudinal axis. In addition, heating equipment may also be provided. The drying unit 2 is controlled by a control unit 4. In addition, the device 1 for drying comprises at least one measuring unit 3 for measuring ambient parameters. Ambient parameters as used here are understood to refer to the ambient conditions that are relevant for the condensation of water on the container surface such as relative atmospheric humidity, air temperature, container temperature, moisture at the container surface, atmospheric pressure.

In this exemplary embodiment the device 1 has three measuring units. The measuring unit 3a measures the surface temperature of the bottle. The measuring unit 3b measures the air temperature and the measuring unit 3c measures the relative atmospheric humidity. The measuring units 3 a, b, c are each connected to the control unit 4 and conduct measurement signals to the control unit 4. The control unit 4 is also connected to a display 6 which displays a signal that corresponds to measured values, for example, and/or indicates whether the heating output must be increased to prevent condensation or whether the heating output can be reduced, depending on the measured parameters. Furthermore, the device 1 has an input device for entering measured ambient parameters. This brings the advantage that certain ambient temperatures such as the bottle temperature need not be measured directly but instead can be entered via the entry 9 if they are known or have been measured elsewhere. The container type and process-specific information (e.g., the type of finishing machine, the temperature of the product in the containers, etc.) can be entered here.

The control unit 4 is designed so that the drying performance of the drying unit 2 can be regulated as a function of the measured ambient parameters. This means that the control unit 4 can automatically regulate the drying performance of the drying unit 2 but it also means that the control unit 4 outputs a signal to the display 6 which indicates to an operator whether he should manually increase or decrease the heating output to prevent condensation or save energy.

The heating output can be regulated, for example, by increasing the energy input, i.e., by increasing or decreasing the fan power, for example, or by increasing or decreasing the quantity of heat delivered to the container for drying.

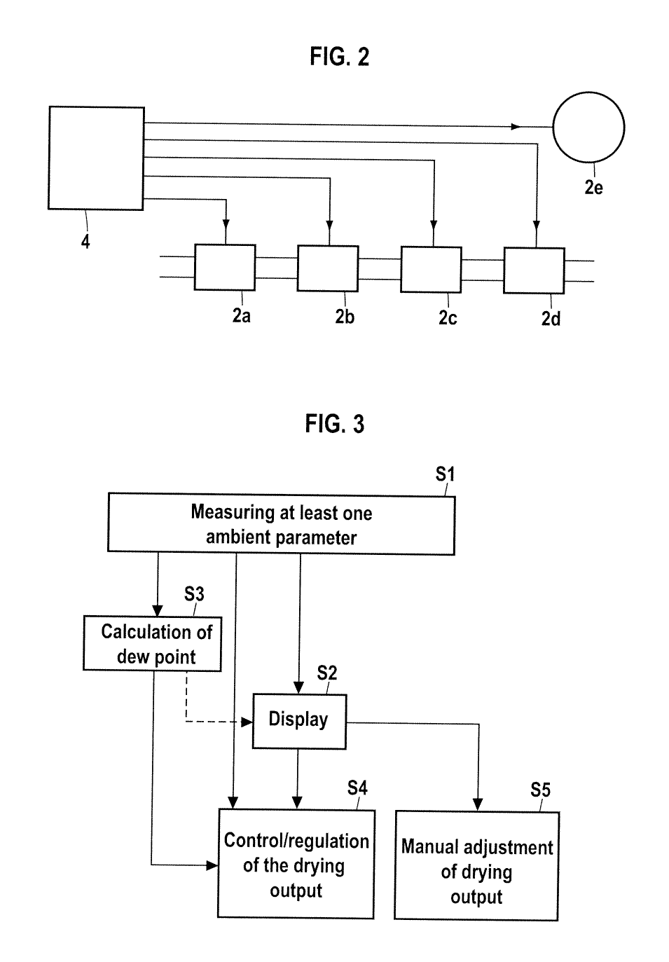

As FIG. 2 indicates, the drying unit 2 may also be constructed of multiple individual parts 2 a, b, c, d such that individual parts of the drying unit are activated or deactivated manually or automatically by the control unit 4 to regulate the drying performance. The complete drying unit with all parts may also be activated or deactivated.

The device 1 may also comprise a device 2e for reducing condensation by reducing atmospheric humidity and/or reducing the air temperature. Such a device 2e may be activated as needed to prevent condensation on the container surface.

As an alternative or in addition to the measure devices 3 shown in FIG. 1, the device 1 may also comprise a measuring unit for measuring the moisture on the container surface of the container 8. Such a measurement may be performed by measuring the resistance, for example. The quantity of water per container may be determined or the relative humidity (%) may be measured.

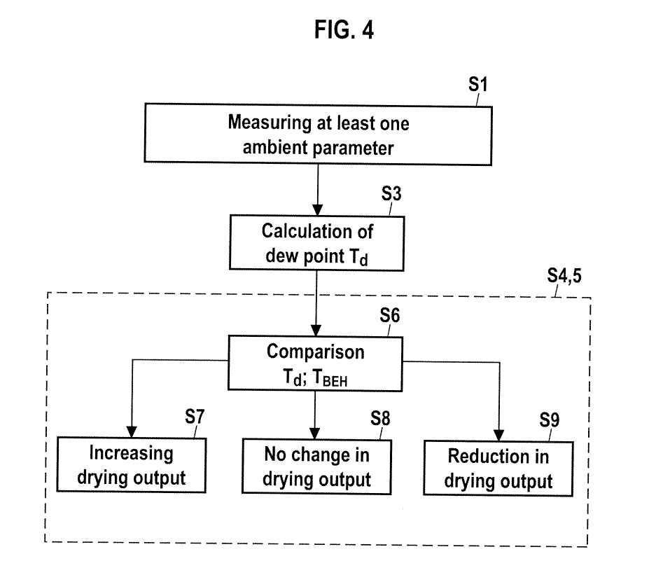

In conjunction with FIGS. 3 and 4, the function principle of the inventive device 1 will be explained in greater detail. The flow chart in FIG. 3 shows several possible sequences.

First, the ambient parameters such as the container temperature, in particular the surface temperature of the container, the air temperature and the relative atmospheric humidity are measured (S1). The ambient parameters that are relevant for condensation are advantageously measured downstream from the inlet 10 in the direction of conveyance. Known ambient parameters may also be input via the input device 9, e.g., via a keyboard. The ambient parameters thereby determined are then sent to the control unit 4.

One possibility of regulating the drying performance of the drying unit 2 consists of determining the dew point at which condensation of water occurs on the container surface; this is represented by the first arrow on the left in FIG. 3 (S3).

The dew point of water in a formal sense is the condensation point of pure water and thus consists of a pair of values comprising the pressure and temperature. However, since these values are conditional upon one another at the phase boundary of a pure substance, the temperature of the dew point is usually used, so the dew point temperature is the same as the dew point. This is thus the temperature of humid air at which it would be saturated with water vapor and would condense with a greater drop in temperature.

The control unit 4 can determine the dew point, e.g., based on the measured relative atmospheric humidity (%) and the respective measured air temperature (° C.) using the following formula (S3):

$${T}_{d} ( ϕ , t ) = \frac{241 , 2 \cdot ln ( \frac{ϕ}{100 \%} ) + \frac{4222 , 03716 \cdot t}{241 , 2 + t}}{17 , 5043 - ln ( \frac{ϕ}{100 \%} ) - \frac{17 , 5043 \cdot t}{241 , 2 + t}}$$

where □=relative atmospheric humidity (%), Td=dew point, t=air temperature (° C.)

The drying performance can then be regulated automatically (S4) or manually (S5), depending on the dew point Td.

As also shown in greater detail in FIG. 4, the dew point Td may be compared with the container temperature Tbeh, for example (S6). If the container temperature and/or the surface temperature of the container 8 is/are below the dew point temperature Td, then condensation of water on the container surface 8 can be expected. For example, if the dew point is the same as or higher than the container temperature, then the drying performance must be increased (S7). If the dew point Td is below the container temperature Tbeh, then the drying unit 2 may be operated only at partial load. If the container temperature Tbeh exceeds the dew point Td by a certain amount, then the drying performance can be reduced (S9). The comparison between the dew point Td and the container temperature Tbeh can also lead to the result that when the container temperature Tbeh does not exceed the dew point by more than a predetermined amount, no change in the drawing performance is necessary (S8). This is just one example of a possible means of regulating the power. Regulation, in particular the predetermined limits, depends on the container type, among other things.

As mentioned above, depending on the dew point, the control unit 4 can automatically control or regulate the drying performance (S4). If the drying performance is to be regulated manually, e.g., by activating and deactivating parts of the drying unit 2 or increasing the energy supplied, then it is advantageous if there is first a display of a signal indicating whether the heating output is to be increased or decreased. With the display, the dew point thus ascertained can also be indicated (S2). Even in automatic control or regulation of the drying performance, there may additionally be a display. In addition or as an alternative, an acoustic signal may also be generated.

Another possibility of regulating the drying performance as a function of the ambient temperature is indicated by the second and third arrows from the left in FIG. 3. The dew point is not calculated here in an intermediate step, as explained above. The regulation occurs directly as a function of the measured ambient parameters that are relevant for condensation such as the relative atmospheric humidity or temperature.

It is also possible to measure the moisture directly on the container surface, in which case this is then compared with a limit value. If the moisture on the container surface is above a certain limit value, then the drying performance must be increased and step S4 or S5 follows. Here again, there may be a display or an acoustic signal in advance (S2).

In steps S4 and S5, it is possible to regulate the amount of energy input for regulation of the drying performance, e.g., to regulate the power of the fan and/or the heating output for the air stream. However, as described previously, parts of the heating unit 2 a, b, c, d, e or the entire heating unit may be activated or deactivated.

The control unit 4 may additionally also control or regulate the drying power as a function of other parameters, e.g., container type or type of downstream finishing machine/finishing process.

1. Device (1) for drying containers (8), comprising
a drying unit (2) for removing water on the container surface, at least one measuring unit (3) for measuring ambient parameters, and a control unit (4) which is designed so that the drying power of the drying unit (2) can be regulated as a function of at least one measured ambient parameter.

2. Device according to claim 1, wherein the measured ambient parameters are sent by the at least one measuring unit (3) to one of the control unit (4) or an input device (9) that is provided for entering ambient parameters.

3. Device according to claim 1, wherein the drying device (1) has a measuring unit (3b) for the air temperature and a measuring unit (3c) for the atmospheric humidity.

4. Device according to claim 1, wherein the drying device includes a measuring unit (3a) for the container temperature.

5. Device according to claim 1, wherein the dr device (1) comprises a measuring unit (3) for measuring the moisture on the container surface.

6. Device according to claim 1, wherein the control unit (4) determines from the measured ambient parameters the dew point at which condensation of water on the container surface occurs.

7. Device according to claim 1, wherein the control unit (4) is connected to a display (6) which displays a signal indicating whether the heating output should be one of increased or decreased as a function of the measured parameters.

8. Device according to claim 7, wherein the power of the drying unit (2) can be regulated manually.

9. Device according to claim 1, wherein the control unit (4) automatically regulates the power of the drying unit (2).

10. Device according to claim 1, wherein the device (1) is situated in front of a treatment machine.

11. Device according to claim 1, wherein the drying unit (2) comprises a device (2e) for reducing condensation by one of reducing atmospheric humidity, or by lowering the air temperature, or combinations thereof.

12. Method for drying containers (8), comprising removing water from the surface of the container (8) with the help of a drying unit (2), and regulating the drying performance of the drying unit (2) as a function of the measured ambient parameters.

13. Method according to claim 12, and measuring at least one parameter from the following group as the ambient parameter:
atmospheric humidity, air temperature, container temperature, air pressure, moisture at the container surface.

14. Method according to claim 12, and determining the dew point at which condensation of water on the container surface occurs.

15. Method according to claim 14, and regulating the drying performance on the basis of a comparison of the container temperature with the dew point determined.

16. Method according to claim 12, and delivering one of a visual or acoustic warning signal when it is ascertained that condensation is to be expected, whereupon the drying performance is increased manually or automatically.

17. Method according to claim 12, and at least a parts of the drying unit (2) is one of activated or deactivated as a function of the measured ambient parameters.

18. Method according to claim 12, wherein the output of the drying unit (2) is regulated automatically as a function of the measured ambient parameters.

19. Device according to claim 4, wherein the container temperature is the surface temperature of the container (8).

20. Device according to claim 10, wherein the treatment machine is a labeling machine.

21. Device according to claim 1, wherein the containers are bottles.

22. Method according to claim 12, wherein the containers are bottles.

23. Method according to claim 17, wherein the activation or deactivation is one of automatically or manually.

24. Method according to claim 17, wherein the entire drying unit is one of activated or deactivated.
